(19) United States
(12) Patent Application Publication
(10) Pub. No.: US 2008/0011671 A1
(43) Pub. Date: Jan. 17, 2008

(54) Expandable strainer

(76) Inventor: Yves Syrkos, Blainville (CA)

Correspondence Address: Franz Bonsang;c/o PROTECTIONS EQUINOX INT'L INC., Suite 224, 4480, Cote-de-Liesse, Montreal, QC, H4N 2R1, US

(21) Appl. No.: 11/484,747

(22) Filed: Jul. 12, 2006

(51) Int. Cl. B01D 29/88

(52) U.S. Cl. 210/469

(57) ABSTRACT

An expandable strainer includes a base having registration means therein for supporting and receiving a plurality of liquid permeable side panels arranged circumferentially in overlapping and interleaving inner and outer rings retained in uniform manner to allow expansion and retraction thereof upon appropriate movement. An expandable bowl is also provided and essentially includes similar features to those of the strainer with solid side panels. The strainer is insertable within the bowl and is rotatable therewithin via a spinner mechanism engaging the rim of the bowl. Rotation of a drive disc provided with a rack meshing with pinions provided on the lid which incorporates the mechanism. The disc describes a concentric path during use and the rack actuates the pinion in so doing, the wheels rotationally impelling the strainer to centrifuge excess water from salad items placed in the strainer. The water so expressed being held within the bowl.

### FIELD OF THE INVENTION

The present invention relates to an expandable strainer and in particular has reference to such a strainer suitable for use in combination with an expandable bowl to provide a salad spinner.

### BACKGROUND OF THE INVENTION

In the culinary field it has been known in the past to utilize expandable elements in order to obviate the need for providing a multiplicity of differently sized versions, e.g. lids, for covering pots or other cookery vessels also of varying dimension.

One example of such an element is described in U.S. Pat. No. 1,322,863 to Bach et al in which there is disclosed an expansible cover for use in connection with cooking vessels, the cover comprising a plurality of overlapping segmental elements presenting a fanlike formation capable of expanding to varying degrees dependent upon the required dimension. This proposal had the disadvantage of many interengaging parts susceptible to wear and for that matter contamination following extended usage.

In the same field it was common many years ago to produce steam puddings and to place the pudding basin within a large saucepan on a support (as a steam flower) which distanced the basin from the bottom of the pan and which also provided an embracing wall in combination with the base. In order to accommodate basins of varying dimension, the wall was of an expandable kind and could be set to the appropriate size. Again, the wall consisted of overlapping petal-like elements, which could move relative one to the other and the end margins could be fixed in the desired position to give the correct size for the basin being used.

It is also known in other fields of application to use adjustable elements to provide versatility with regard to size. For example U.S. Pat. No. 2,456,912 to Burrows describes a collapsible and adjustable filter and strainer particularly for filtering fluid materials such as paint. Its stated object is to facilitate usage in combination with paint cans or receptacles of various diameters by folding the frame portion of the filter on prearranged radial fold lines to reduce or increase the circumference without cutting the frame portion or the reticulate screen and the filtering element carried thereby. The filter and strainer of Burrows was coniform and capable of adjustment to vary the diameter of the cone base thus affording adaptability to any given can size within the range of its maximum and minimum circumference, a simple tab being provided to secure the strainer in the desired size condition. The strainer of this proposal was in one piece and of limited adjustment.

There is perceived to be a need for an adjustable strainer and a complementary bowl of adjustable dimension which in combination provide a versatile salad spinner.

### SUMMARY OF THE INVENTION

It is therefore a general object of the present invention to provide an improved expandable strainer, particularly a salad bowl.

A further object of the present invention is to provide an expandable bowl for use in combination with said strainer.

A still further object of the present invention is to provide a spinner mechanism for the strainer in situ within the bowl.

An advantage of the present invention is that the expansion of the strainer is easily accomplished by virtue of a relatively simple and yet novel and inventive arrangement of overlapping and interleaving elements, with the bowl being of similar construction.

Another advantage of the present invention is that the expandable strainer is insertable within the bowl and is mountable and demountable therefrom with ease.

Accordingly a first aspect of the present invention provides an expandable bowl comprising a base, registration means on the base, a relatively outer ring and a relatively inner ring of overlapping and interleaving segmental side panels constituting in circumferential combination the side of the bowl, each panel having a lower end registering with the registration means in such manner as to allow relative movement as between each panel and the base, guide and retention means provided for adjacent panels, the guide means being adapted in use to guide relative radial and circumferential movement of the panels whereby the diametral and circumferential dimensions of the bowl are variable whilst maintaining the continuity and integrity of the side of the bowl, and mounting means on the base for the reception of an expandable strainer.

The segmental side panels are preferably so formed as to provide sealing engagement between one another.

According to a second aspect of the present invention an expandable strainer for insertion within and in spaced relation to the bowl constructed in accordance with the first aspect of the invention, the strainer comprising a base, registration means on the base, a relatively outer ring and a relatively inner ring of overlapping and interleaving segmental foraminous side panels constituting in circumferential combination the side of the strainer, each panel having a lower end registering with the registration means in such manner as to allow relative movement as between each panel and the base, guide and retention means provided for adjacent panels, the guide means being adapted in use to guide relative radial and circumferential movement of the panels whereby the diametral and circumferential dimensions of the strainer are variable whilst maintaining the continuity and integrity of the side of the strainer, and, typically, mounting means on the base of the strainer for rotating engagement with the mounting means on the base of the bowl.

According to a third aspect of the present invention a spinner mechanism for the expandable strainer in situ within the bowl comprises a lid for covering the bowl and the strainer, the lid being provided with drive means for spinning the strainer, the drive means including drive wheels arranged for friction engagement with a top margin of the strainer, each wheel being rotatably mounted on an axle extending from the lid and fixable to a panel of the bowl, a drive pinion connected to each wheel and meshing with a circular toothed rack provided on the lid, a rotatable drive disc concentrically mounted in relation to the axis of the strainer and carrying the circular toothed rack, and an actuating handle rotatably mounted on the disc and adapted in use upon actuation to move the rack on an concentric path to drive the drive wheels and thus the strainer.

Conveniently, each drive pinion is radially slidably moveable relative to the lid and the rack in order to adjust to the specific size of the strainer during its use.

According to a fourth aspect the invention provides a salad spinner comprising in combination the expandable bowl, the expandable strainer and the spinner mechanism in accordance with respectively the first, second and third aspects of the invention.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is an exploded top perspective view of an expandable bowl and of an expandable strainer in accordance with an embodiment of the present invention;

FIG. 2 is an enlarged broken perspective scrap view of a detail of the strainer, showing a hinged handle;

FIG. 3 is a top perspective view of the bowl showing the extent of expansion possible;

FIG. 4 is a further exploded broken perspective scrap view of two adjacent panels of the bowl showing the manner of interleaving;

FIG. 5 is an enlarged partial cross sectional view on the line 5-5 of FIG. 3;

FIG. 6 is a yet further scrap view of two adjacent interleaved panels;

FIG. 7 is a detailed perspective view of part of the assembly of the bowl with the strainer inserted therein and a supermounted lid with a spinner mechanism in accordance with an embodiment of the present invention;

FIG. 8 is a simplified enlarged cross section on the line 8-8 of FIG. 7; and

FIG. 9 is a view similar to that of FIG. 7 with some parts removed or partially broken for the sake of clarity.

### DETAILED DESCRIPTION OF THE PREFERRED EMBODIMENTS

With reference to the annexed drawings the preferred embodiment of the present invention will be herein described for indicative purpose and by no means as of limitation.

Referring to the figures, there is shown generally at 1 an expandable bowl in accordance with an embodiment of the present invention intended for containing salad (not shown) with a strainer 2 of similar expandable type illustrated above the bowl with an arrow A indicating its insertion path thereinto.

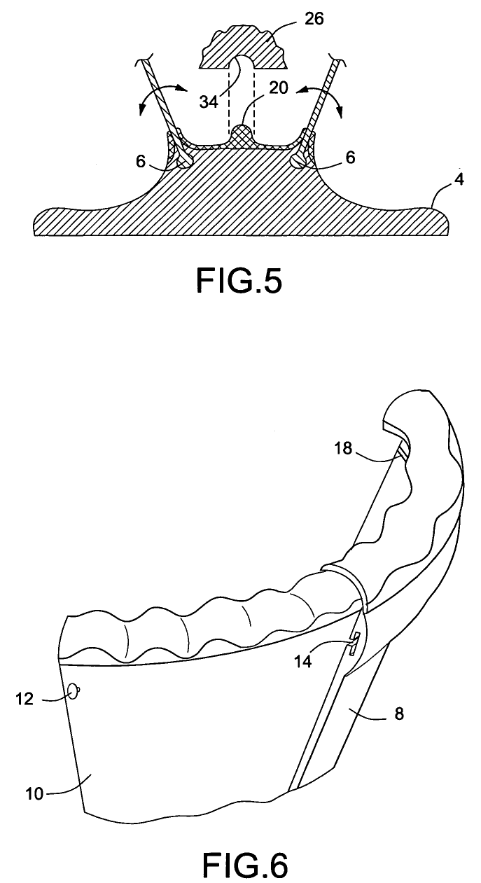

The bowl 1 comprises a base 4 with a registration means 6 shown in section more particularly in FIG. 5 for the reception and retention of a ring of relatively outer panels 8 and a ring of relatively inner panels 10, both rings being capable of limited movement radially of the bowl 1.

The outer and inner rings of panels 8, 10 overlap and interleave with one another as depicted in the drawings and are guided and retained together in petal-like formation by means of a pin and slot arrangement 12, 14. In particular, as can more clearly be seen in FIGS. 4 and 6, the relatively outer face of each inner panel 10 is provided at its peripheral edge with a T-shaped pin 12 for engagement in a complementary slot 14 formed in the inner surface of each outer panel 8. This interengagement allows relative but controlled and guided movement of the inner panels and the outer panels to permit expansion or contraction in the diametral and circumferential size of the bowl 1 thus affording variability in dimensions.

In the smallest mode or configuration of the bowl, the outer panels 8 continuously cover approximately 360° whilst each of the inner panels 10 covers approximately 45°.

The base 4 of the bowl 1 is provided at its center with a fulcrum 20 upon which in use the strainer 2 sits as indicated in FIG. 5. The strainer 2 is expandable in character and essentially consists of the same basic features as the bowl in that it comprises two rings of outer and inner panels 22, 24 which overlap and interleave as previously explained in relation to the bowl 1, the panels being received within a base 26 provided with registration means (not shown) allowing inward and outward radial movement of the panels. The panels 22, 24 are of foraminous, for example perforated or reticulated, material and together present a rolled-over rim 25. The same type of pin and slot arrangement is provided on the strainer for adjacent and overlapping panels as for the bowl. The strainer 2 is provided in opposing outer panels 22 with a ring-shaped ear handle 30 which is pivotally mounted and is retractable within the strainer through a slot 32 for that purpose, such that the strainer can be easily removed from the bowl with ears located inside and carried separately with ears hinged outside.

The base 26 is formed on its under surface with a recess 34 which in position within the bowl 1 receives the fulcrum 20 about which in use the strainer may spin in a manner to be described below.

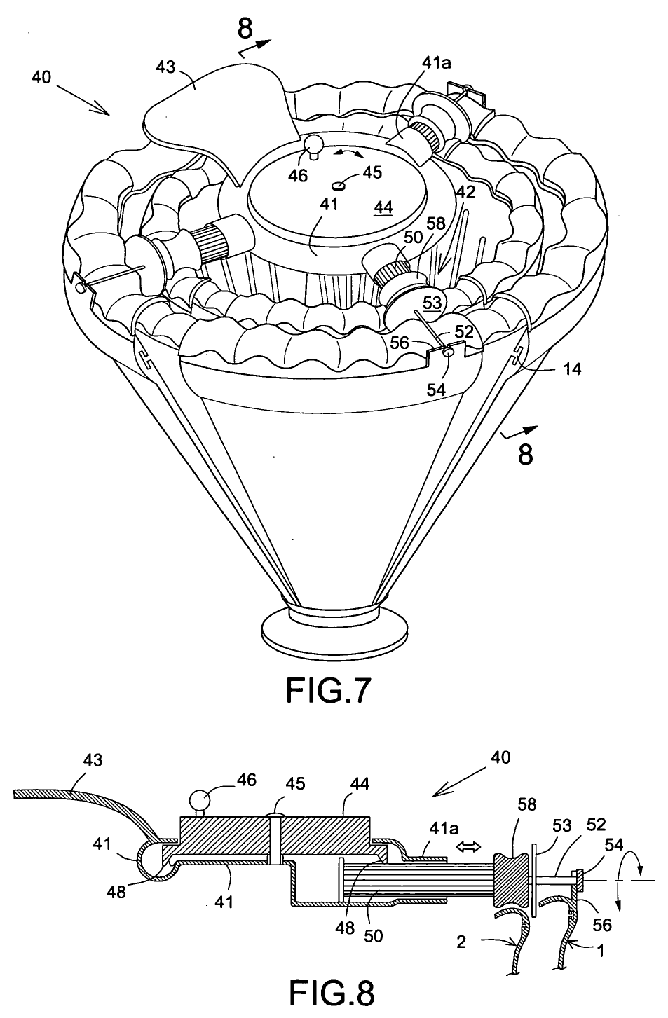

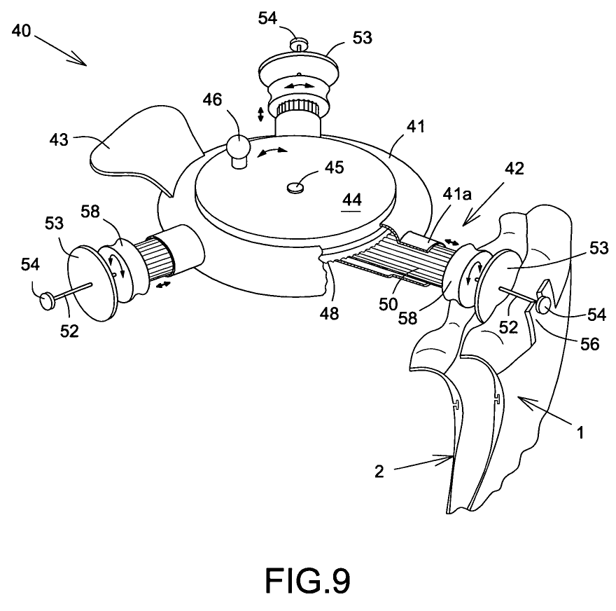

Referring now particularly to FIGS. 7, 8 and 9 there is shown the combination of the strainer 2 within the bowl 1 together with a lid 40 which incorporates a salad spinning mechanism 42 for engaging the strainer 2 and spinning the same within the confines of the bowl 1.

The spinning mechanism 42 is provided with handles 43 extending from the spinner housing 41 and includes a circular actuating disc 44 with a knob 46 rotatably mounted on its outer surface within the housing 41 as shown, the disc being formed on its relatively inner surface at the periphery thereof with a circular toothed rack 48 engaging three rotatable pinions 50 of elongate form, each pinion being mounted on an axle 52 and extending radially from the housing through corresponding housing sleeves 41a being radially slidably moveable relative to the housing sleeves 41a and the rack 48 to adapt to the configuration of the strainer 2 dictated by the relative positions of the panels 22, 24. The axles 52 are equi-spaced circumferentially of the lid 40. Each axle 52 extends from within the lid 40 and beneath the toothed rack 48 to a bearing point 54, which is supported by a recessed lug 56 formed on the upper margin of an outer panel 8 of the bowl 1. Each axle 52 carries a grooved friction roller 58 engageable with the upper rim 25 of the panels 22, 24 of the strainer 2; a spacer 53 is mounted on each axle 52 between the roller 58 and the bearing point 54 to prevent the strainer from fouling the bowl. The rollers 58 are fixed to the pinions 50 and are thus rotatable therewith.

In position on the strainer 2 the spinner mechanism 42 is substantially concentric in relation to the center thereof.

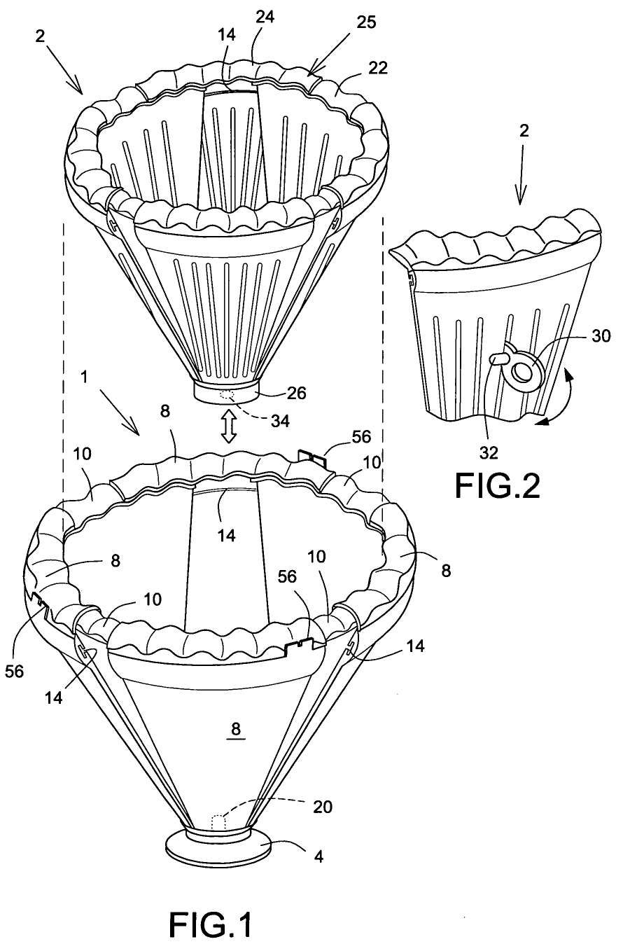

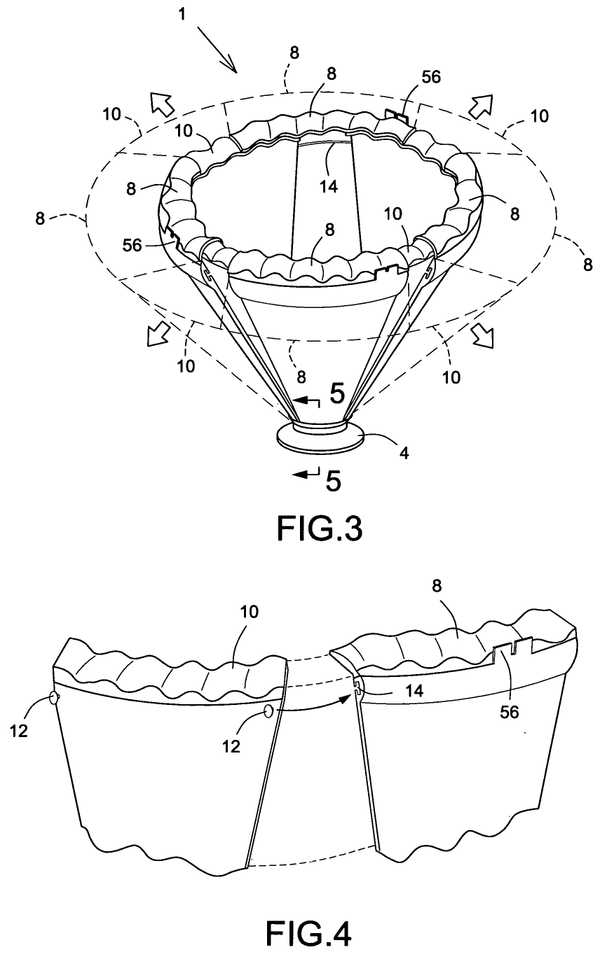

In practice, the bowl 1 is set to its required dimension by moving the panels 8, 10 either in towards the center or outwardly to decrease or increase its diametric and circumferential extent. In similar vein the strainer 2 is also size-adjusted with its corresponding panels 22, 24 being suitably radially moved, the resultant dimension of the strainer being less than that of the bowl for ease of insertion and to leave a gap internally between the two. The placement of the strainer within the bowl merely requires insertion as shown by arrow A in FIG. 1 with the bases of the two vessels interengaging through the agency of the fulcrum 20 and recess 34 thereby allowing free rotational movement as between the inner strainer 2 and the bowl 1.

Washed salad items, for example lettuce and/or onions, are placed within the strainer 2 and the lid 40 is placed over the bowl and the strainer such that the bearing points 54 of the axles 52 engage the recessed lugs 56 with the grooved rollers 58 being radially adjusted from the housing 41 for properly contacting the rolled over rim 25 of the strainer. In order to release excess water from the salad items, the knob 46 on the actuating disc 44 is held and the disc rotated in either clockwise or anti-clockwise direction about its center 45 causing the toothed rack 48 to turn the pinions 50 and thus the rollers 58, which in turn occasions rotary motion of the strainer. The rotation of the disc is concentric and thus the rack actuates the pinions 50 during its operation. The centrifugal force generated causes expulsion of the excess water into bowl 1 for subsequent discharge, thus drying off the salad items for use in the absence of that excess water.

The present invention thus provides a relatively simple expandable bowl and strainer with a spinner mechanism formed in the lid therefor. The adjustment of the size of the bowl and the strainer is achieved with ease.

The materials from which the components of the invention are made may be plastics or metal, such as stainless steel, of approved specification for use with foodstuffs.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. An expandable strainer, the strainer comprising a base, registration means on the base, a relatively outer ring and a relatively inner ring of overlapping and interleaving segmental foraminous side panels constituting in circumferential combination the side of the strainer, each panel having a lower end registering with the registration means in such manner as to allow relative movement as between each panel and the base, guide and retention means provided for adjacent panels, the guide means being adapted in use to guide relative radial and circumferential movement of the panels whereby the diametral and circumferential dimensions of the strainer are variable whilst maintaining the continuity and integrity of the side of the strainer.

2. The strainer of claim 1 wherein the foraminous panels are of perforate or reticulated form.

3. The strainer of claim 1 wherein the mounting means on the base of the bowl comprises a recess.

4. The strainer of claim 1 wherein at least two diametrically opposed outer panels are provided with ring-shaped ear handles retractable within slots formed within the panels.

5. The strainer of claim 1 wherein the guide and retention means comprise a pin and slot arrangement.

6. The strainer of claim 4 wherein the pin is T-shaped and the slot is of complementary form.

7. The strainer of claim 4 further including mounting means on the base of the strainer for rotating engagement with a receiving bowl.

8. An expandable bowl for receiving the expandable retainer of claim 6, the bowl comprising a base, registration means on the base, a relatively outer ring and a relatively inner ring of overlapping and interleaving segmental side panels constituting in circumferential combination the side of the bowl, each panel having a lower end registering with the registration means in such manner as to allow relative movement as between each panel and the base, guide and retention means provided for adjacent panels, the guide means being adapted in use to guide relative radial and circumferential movement of the panels whereby the diametral and circumferential dimensions of the bowl are variable whilst maintaining the continuity and integrity of the side of the bowl, and mounting means on the base for the reception of the mounting means on the base of the strainer in rotating engagement therewith.

9. The bowl of claim 7 wherein the segmental side panels of the bowl provide sealing engagement between one another.

10. The bowl of claim 7 wherein the guide and retention means of the bowl comprise a pin and slot arrangement.

11. The bowl of claim 7 wherein the mounting means of the bowl comprises a fulcrum.

12. The bowl of claim 7 wherein at equi-spaced locations peripherally of the top rim of the bowl recessed support lugs are provided on the relatively outer panels.

13. The bowl of claim 11 wherein three support lugs are provided.

14. A spinner mechanism for the strainer of claim 6 and the bowl of claim 7, the spinner mechanism comprising a lid for covering the bowl and the strainer, the lid being provided with drive means for spinning the strainer, the drive means including drive wheels arranged for frictional engagement with a top rim of the strainer, each wheel being rotatably mounted on an axle that extends from the lid and is fixable to a panel of the bowl, a drive pinion connected to each wheel and meshing with a circular toothed rack provided on the lid, a rotatable drive disc concentrically mounted in relation to the axis of the strainer and carrying the circular toothed rack, and an actuating handle rotatably mounted on the disc and adapted in use upon actuation to move the rack to drive the drive wheels and thus the strainer.

15. The spinner mechanism of claim 13 wherein the drive means comprises a drive disc mounted on the lid provided with an actuating knob.

16. The spinner mechanism of claim 13 wherein the wheels are grooved to engage the rim of the strainer.

17. The spinner mechanism of claim 13 wherein a space is provided as between each wheel and the respective bowl panel.

18. The spinner mechanism of claim 13 wherein the wheels are equi-spaced circumferentially of the lid.

19. The spinner mechanism of claim 15 wherein three wheels are provided.

20. The spinner mechanism of claim 13 wherein the lid is provided with at least one handle.

21. The spinner mechanism of claim 13 wherein each said drive pinion is radially slidably moveable relative to the lid and the rack.

22. A salad spinner comprising the expandable bowl of claim 7, the expandable strainer of claim 6 and the spinner mechanism of claim 13.
